(19) United States
(12) Patent Application Publication
(10) Pub. No.: US 2022/0210087 A1
(43) Pub. Date: Jun. 30, 2022

(54) SYSTEM AND METHOD FOR IN-LINE IN-BAND NETWORK TELEMETRY WITH ADAPTIVE PACKET LENGTH

(71) Applicant: Arista Networks, Inc., Santa Clara, CA (US)

(72) Inventors: Rajshekhar Biradar, Bangalore (IN); Naveen Kumar Devaraj, San Jose, CA (US)

(21) Appl. No.: 17/361,796

(22) Filed: Jun. 29, 2021

(30) Foreign Application Priority Data
Dec. 24, 2020 (IN) 202041056317

(51) Int. Cl. H04L 12/805; H04L 12/26; H04L 12/801

(52) U.S. Cl. CPC H04L 47/365; H04L 47/17; H04L 43/04

(57) ABSTRACT

Systems and methods for managing a data packet's maximum transmission unit (MTU) limit in an in-band telemetry (INT) network are disclosed. The methods include a downstream network element receiving a packet with INT instructions and in response to determining that adding its own metadata would exceed the allowed MTU limit at its egress interface, generating and forwarding a telemetry report containing existing and new metadata to the designated collector, and forwarding the received packet without any metadata to the next hop.

The methods forward the telemetry report to the collector when the packet's MTU limit is exceeded and thereby avoids uncontrolled growth of the packet size.

### CROSS REFERENCE TO RELATED APPLICATIONS

Pursuant to 35 U.S.C. § 119(a), this application is entitled to and claims the benefit of the filing date of Application No. 202041056317, filed Dec. 24, 2020 in the country of India, the content of which is incorporated herein by reference in its entirety for all purposes.

### FIELD OF INVENTION

Embodiments of the present invention relate to managing packet transmission capacity for collecting in-band telemetry data.

### BACKGROUND

In-band telemetry (INT) is a network monitoring and troubleshooting framework that is protocol-independent and allows insight into network packet flow by obtaining real-time packet processing details at each node along a packet's path in the network. When implemented, INT telemetry data collected at an INT configured node can be useful in obtaining a deeper understanding of network operations.

INT operates by an INT source instrumenting the packet with INT instructions. This includes embedding the packet with INT instructions and adding the capability for the packet to carry INT metadata. As the instrumented packet traverses hop by hop to its destination, each node/hop follows the INT instructions, collects INT telemetry data and forwards INT metadata to the collector. At times the telemetry data is reported directly from each node and at times telemetry metadata is embedded to the packet header and stacked at each node along and forwarded by the end node/sink to the collector.

The INT instructions embedded in the header of the packet instruct the type and quantity of telemetry data to be collected at each node. The telemetry data collected contains information about the packet, such as latency, jitter, bandwidth utilization, and queue depth, from each node along the packet's path. The data makes it easier to analyze a variety of metrics, such as, when a packet enters and exits each node, rate of packets along a path, how long a packet queues at each node, network congestion, bandwidth usage and other metrics that can help improve network flow or troubleshoot issues.

There are a few types of INT implementations. One implementation is referred to as postcard telemetry or postcard-based telemetry. This implementation does not require packets to carry telemetry metadata. Instead, telemetry INT metadata collected at each node is directly exported to the designated collector. The INT instructions embedded in the postcard packet's header guide the node to collect and report the telemetry metadata directly such that the packet header is not embedded with telemetry metadata. Although there are some advantages to the postcard implementation, a drawback of this implementation is that the collector receives too many packets from every node causing excessive bandwidth utilization and overburdening the collector's CPU to process all the received packets.

In another INT implementation, known as a classic embedded (inline) INT, telemetry metadata is embedded at every node along the path and a sink node exports the telemetry metadata to the collector. In comparison with postcard telemetry, this method is efficient in the sense that only the sink node sends the reports thereby significantly reducing the amount of telemetry packets and reports sent to the collector. However, the inline INT implementation also includes several drawbacks. One such major drawback is that inline telemetry implementation significantly increases the packet's original size by stacking metadata to the header at each node traversed by the packet. Because every node stacks its metadata on top of the metadata stacked by a previous node, a longer forwarding path with several nodes results in a longer stack and a longer packet ultimately reaching the packet Maximum Transmission Unit (MTU) limit (also referred to as MTU capacity, packet transmission limit, packet transmission capacity, transmission capacity, packet length, or packet adaptive length). Once the MTU limit is reached, either INT telemetry cannot be applied, or the packet needs to be fragmented. Limiting the data size or path length reduces the effectiveness of INT. Fragmentation of packets adds overhead of reassembling the fragments at the collector. Additionally, once the MTU limit is reached the packet is dropped because it cannot carry more than its MTU limit and INT telemetry cannot be applied to nodes that are yet to receive the packet. As such, there is a need for a method to efficiently manage MTU limit while reducing or minimizing bandwidth utilization in an in-band telemetry environment.

### BRIEF DESCRIPTION OF THE DRAWINGS

The various objects and advantages of the disclosure will be apparent upon consideration of the following detailed description, taken in conjunction with the accompanying drawings, in which like reference characters refer to like parts throughout, and in which:

FIG. 1 shows an exemplary system environment for In-band telemetry, in accordance with some embodiments of the disclosure;

FIG. 2 is a block diagram of an in-band telemetry system 100 and an exemplary path taken by a packet using the components of the in-band telemetry system, in accordance with some embodiments of the disclosure.

FIG. 3 is a flowchart of a process performed by a network element for managing packet transmission capacity, in accordance with some embodiments of the disclosure;

FIG. 4 is a flowchart for analyzing packet transmission capacity, in accordance with some embodiments of the disclosure;

FIG. 5 is an exemplary INT header, in accordance with some embodiments of the disclosure;

FIG. 6A is a block diagram of an INT metadata stack, in accordance with some embodiments of the disclosure;

FIG. 6B is a block diagram of an INT metadata stack with new metadata, in accordance with some embodiments of the disclosure; and

FIG. 7 shows components of a system for In-band telemetry, in accordance with some embodiments of the disclosure.

### DETAILED DESCRIPTION

In accordance with some disclosed embodiments, systems and methods for managing packet transmission capacity for collecting in-band telemetry data are disclosed.

In accordance with some embodiments disclosed herein, limitations of current INT implementations are overcome by managing the growth of the packet size and preventing the packet size from reaching or exceeding its transmission capacity limit. In some embodiments, the packet size is analyzed at each network element that is encountered by the packet as it traverses through the network. A determination is made if the packet size is reaching its transmission capacity limit, and if so, packet transmission capacity management actions are performed by the network element to keep the packet size within its transmission capacity limit. As a result of managing packet transmission capacity, because only packets reaching their capacity are sent to the collector, lesser packets are sent from each network element thereby utilizing lesser network bandwidth and also lesser CPU processing at the collector to process the received packets.

In some embodiments disclosed herein, a packet is embedded by an INT source with an INT header that includes INT instructions. The instructions embedded in the packet, also referred to as INT packet or packet comprising INT data, instruct a downstream network element to collect telemetry metadata in accordance with the instructions and forward the collected metadata to a designated collector.

In one embodiment, the network elements are also configured to analyze packet transmission capacity (also referred to as packet size or packet length). In another embodiment, the packet carries with it instructions that are embedded by the INT source that guide the network elements to analyze packet transmission capacity without the need to specifically configure the network elements for such analysis.

Regardless of whether the network elements are configured to analyze packet transmission capacity or are able to perform such analysis based on the instructions provided in the INT packet, the network elements manage transmission capacity by emptying currently occupied transmission capacity and creating space if a determination is made that adding INT metadata to the packet would result in exceeding the packet's MTU limit. The creation of transmission space is analogous to emptying the transmission bucket before it is full, i.e., if the new data does not fit in the bucket, the bucket is emptied, and space is created to accommodate the new data. As such, the network element analyzes each packet received to determine packet's transmission capacity at its egress interface and takes packet management action as described below.

In one embodiment, the network element performs the transmission capacity analysis by determining the total MTU limit. The network element also determines the current occupancy of the packet at the ingress port. Because the packet may already include metadata from preceding nodes before it reaches the current node, also referred to as aggregated metadata, some or all the packet's transmission capacity may already be occupied by previous node metadata.

Along with determining transmission capacity, the network element reads the INT instructions from the packet header to determine the type and quantity of telemetry metadata that is to be collected from the network element in accordance with the INT instructions, i.e., its own metadata. The network element also evaluates the transmission capacity required to embed the packet with its own telemetry metadata. An analysis is performed to determine if the existing transmission capacity of the packet when it was received at the ingress port and the new telemetry metadata transmission capacity required from the network element, together exceed the total MTU limit of the packet. In other words, can the network element fit its own telemetry metadata to the existing packet without exceeding the MTU limit.

In another embodiment, the configured INT network element receives the packet and calculates a difference between the total MTU limit of the packet's egress interface and current packet size to determine the MTU space remaining. In response to the determination of space remaining, the network element determines if the space is adequate to fit its own metadata.

If a determination is made that adding the telemetry metadata from the network element to the existing packet exceeds the packet's MTU limit, then the network element takes packet transmission capacity management actions to ensure that the packet stays within its MTU limit. These actions include sending telemetry metadata from preceding network elements to the INT collector to make space for the new telemetry metadata that is to be added. The new telemetry metadata generated at the network element is also sent along with the preceding metadata to the collector. In one embodiment, a telemetry report is sent to the collector. The telemetry report contains metadata from preceding network elements, newly generated metadata, original packet header, and the INT header. Metadata from preceding network elements is stripped from the packet, thereby emptying the transmission capacity bucket and creating space for the next hop network element to add its own metadata.

If a determination is made that adding the network element's own telemetry metadata to the aggregated telemetry metadata from the previous network elements does not exceed the MTU limit, then the network element embeds its own INT metadata to the packet and forwards the packet to the next hop/network element.

Each next hop performs a similar analysis to determine if adding its own metadata would exceed the packet's MTU limit and takes similar action of a) either emptying the transmission capacity bucket by sending a telemetry report to the collector and forwarding the original packet empty of any metadata to the next hop or b) forwarding the packet with newly generated metadata (and possibly metadata from preceding network elements) while there is still MTU capacity left for the next hop to add its own metadata.

In accordance with some disclosed methods and embodiments, telemetry data is sent to the collector from network elements when the packet's MTU limit is reached. This approach maximizes the transmission capacity of the packet by stacking metadata from as many network elements as possible and emptying the transmission bucket, by sending INT telemetry data to the collector, before or when the MTU limit is reached. Maximizing transmission capacity by not having every network element send a packet with INT telemetry data to the collector until the transmission bucket is full or nearly full results in reducing (and, preferably, minimizing) the number of packets comprising INT metadata received by the collector thereby leading to a more efficient network.

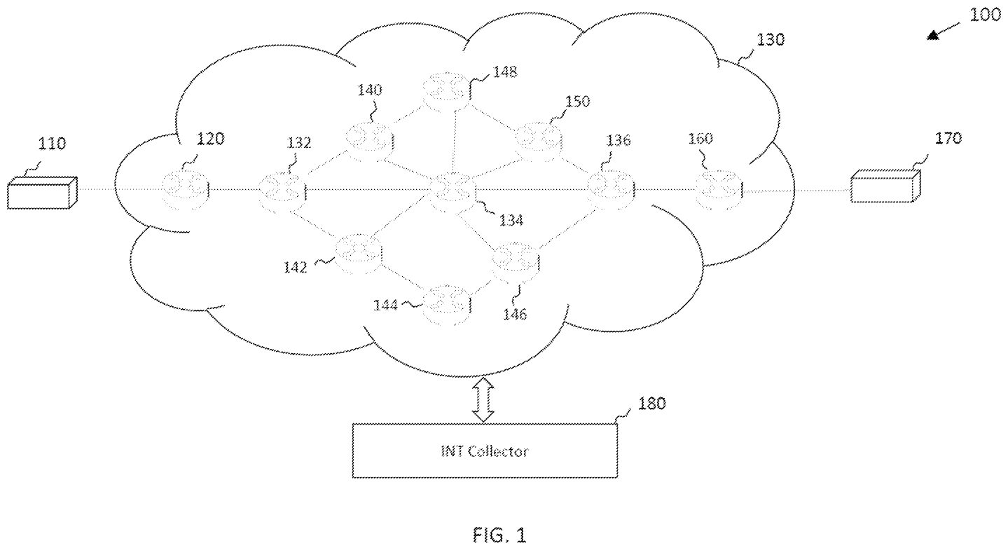

FIG. 1 shows an exemplary system environment 100 for in-band telemetry, in accordance with some embodiments of the disclosure. The system 100 includes a host 110, a first network element 120, a network 130 of a plurality of network elements 120-160 including a last network element 160, and a receiver 170. The plurality of network elements 120-160 are connected to an INT collector 180 through network 130.

Although a certain number of network elements, and routes between the network elements are depicted, the system 100 for in-band telemetry is not so limited. It is understood that other types of network topologies that include different combinations of network elements and links, e.g., greater or fewer number of network elements, routers, and switches than shown in FIG. 1, may be employed to route packets and collect telemetry metadata from network elements encountered by the packet along its path to a destination.

The network may include a host 110 and a first network element 120 or a combination of other devices at the ingress point. For example, the network may include an edge element, a hub, or other network elements, servers or devices that connect to the first network element 120.

The host 100, also referred to as the INT source, may be a computer, server, mobile device, or other electronic device capable of routing and embedding packets with INT data and connecting to the first network element and/or to the network 130. The host 110 is a device that receives packets from originating sources of traffic, such as a database or a web browser. When acting as an INT source, or INT header source, the host 110 functions to embed packets received from other originating sources with an INT header. Alternatively, in some instances, the host 220 may be both an originating source of data as well as an INT source that embeds the packet for INT telemetry.

The first network element 120 may act as the ingress point or the first hop for a packet that is sent from source 110 and destined for receiver 170. The first network element 120 can be a switch, router, hub, bridge, gateway, etc., or another type of packet-forwarding device that can communicate with network 130. In one embodiment, the first network element 120 can be a virtual machine. In some embodiments, the first network element 120 may be selected as the INT source.

The network 130 includes a plurality of network elements 132-150. These network elements 132-150 can be a switch, router, hub, bridge, gateway, virtual machine or other types of packet receiving and forwarding devices. The plurality of network elements 132-150 are connected to each other and the first hop network element 120 and the last hop network element 160 through network 130. The last hop 160 is capable of removing INT header and forwarding the packet to the receiver 170.

Each network element 120-160 is configured for receiving and forwarding packets. It is also configured to read and follow INT instructions embedded in the header of an incoming packet. As instructed through the INT instructions, each network element collects telemetry data and adds it to the packet header. The network element makes a decision based on a MTU limit on next steps. For example, the network element may strip previous metadata that was embedded in the packet header prior to the packet being received at the network element's ingress port/interface and forward the stripped metadata to a designated INT collector. The network element may also update the packet by adding its own metadata and forwarding the packet to the INT collector or alternatively to the next hop. The decisions made will be guided by the analysis and determinations made by the network element relating to the MTU limit at its egress interface.

The metadata collected by the network element, also referred to herein as new metadata, can be telemetry metadata collected by the network element based on the INT instructions provided in the embedded packet header. The INT instructions guide the network element on the type, quantity, and frequency of telemetry metadata to be collected. Some examples of metadata collected include packet time stamps at ingress and egress points of the network element, path information, latency information, jitter, bandwidth utilization, queue depth, and other packet related data. The metadata collected represents the status of the packet and packet flow when it was processed by the network element.

The network 130 can be a wired or wireless network. It may be a local area network, wide area network, a virtual private network, or another type of network that provides the capability to collect and report INT telemetry data. It may also be an Ethernet connection. The INT collector 180 may connect to the network through a variety of means (e.g., through an interface such as RS-232 or other wired or wireless and digital or analog means). The INT collector 180 may be configured to receive INT telemetry data from all network elements 120-160 in network 130.

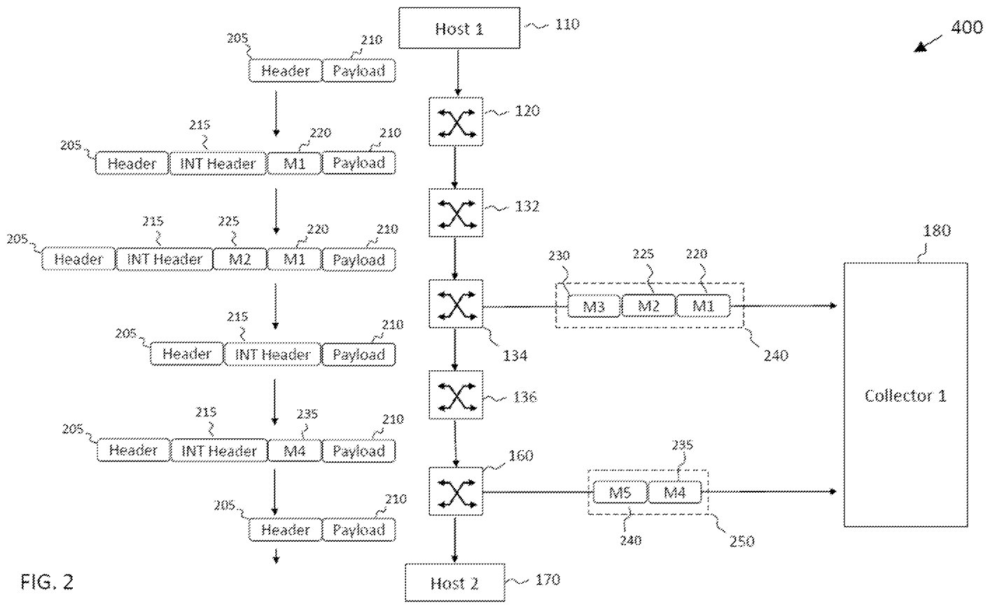

FIG. 2 is a block diagram of an in-band telemetry system 100 and an exemplary path taken by a packet using the components of the in-band telemetry system, in accordance with some embodiments of the disclosure. The embodiments of FIG. 2 also reduce/minimize network bandwidth utilization by sending a telemetry report to the collector when the MTU capacity is full or nearly full

System 100 includes Host 1 (110), receiving Host 2 (170), and a plurality of network elements 120, 132, 134, 136, and 160 in-between Host 1 and Host 2 that form a series of next hops along a route of the packet to its destination node Host 2 (170). System 400 also includes a collector 180 that is the designated collector for the in-band telemetry system. Although a certain number of system components are depicted, other topologies and more or less system components are also contemplated.

As shown in FIG. 2, the first network element 120, receives the packet from the INT source. The received packet includes a header 205 and payload 210. The first network element 120, embeds the packet with an INT header 215, which includes instructions for a downstream network element (e.g., network elements 132, 134, 136, and 160) to calculate packet MTU limit and make bandwidth saving decisions accordingly. The header also includes INT instructions that the downstream network elements may follow to collect and send INT metadata to collector 180.

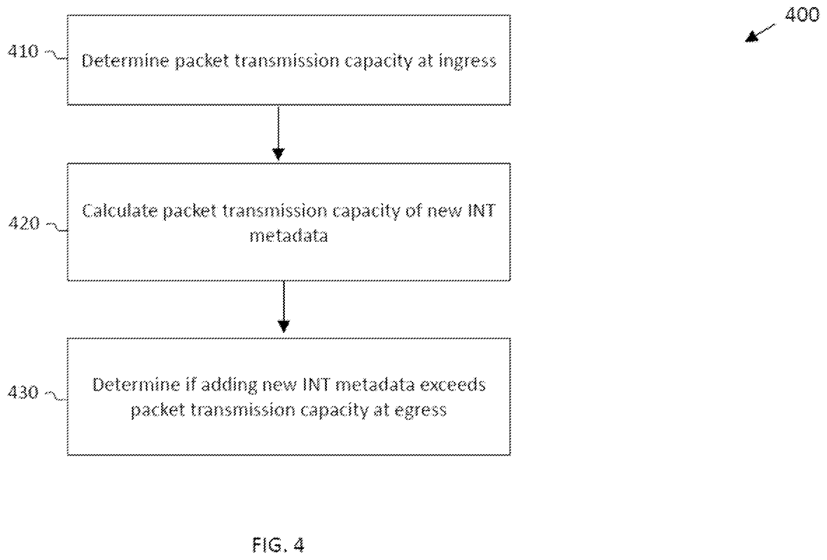

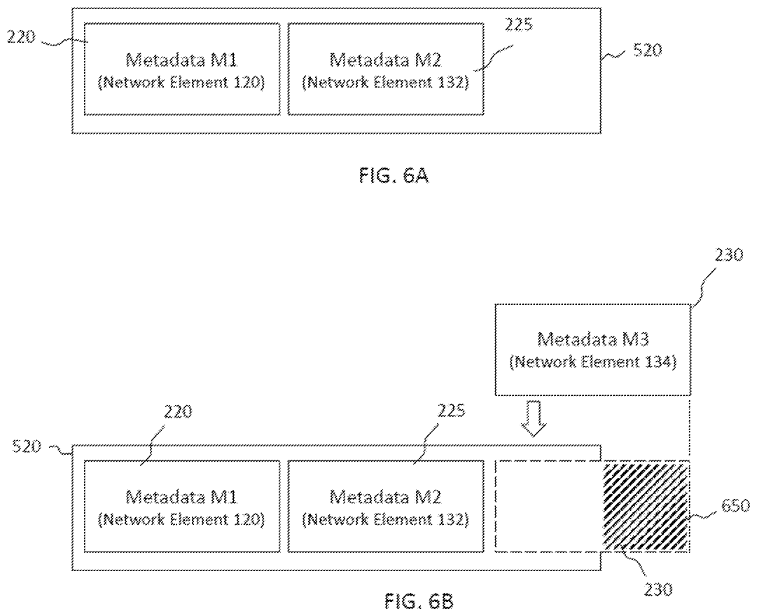

In one embodiment, each network element receiving the packet from a preceding network element determines whether adding its own metadata would exceed the packet's MTU limit at its egress interface. For example, network element 132 receiving a data packet from a preceding network element 120 would determine if adding its own metadata M2, to the received data packet having metadata M1 embedded at the preceding network element 120, would exceed the packet's MTU limit at network element 132's egress interface. Likewise, all network elements in the path of the packet would make the same determination when a packet is received. The analysis and calculations performed by the network elements to determine packet MTU limit at its egress interface are described further in FIGS. 4, and 6A-6B.

In one embodiment, a determination is made that adding new INT metadata, such as metadata M3 at network element 134, would exceed the packet's MTU limit at the egress of the network element 134. In response to such determination, the network element would embed the maximum amount of metadata to the packet and forward the packet to the collector 180. In one embodiment, a telemetry report that comprises, metadata from preceding network elements, newly generated metadata from the receiving network element, original packet header, and an INT header, is sent to the collector.

In one embodiment, network element 134 determines that 75% of the packet's MTU limit is already occupied with previously embedded metadata M1 and M2 and that its own newly generated metadata requires 40% MTU capacity. In one embodiment, because only 25% capacity remains to maximize MTU limit, and the newly generated metadata M3 requires 40%, i.e. 15% more MTU capacity available, the network element prepares and forwards a telemetry report that contains metadata M1, M2, and M3 and forwards the telemetry report to the collector 180. The metadata from preceding network elements is stripped from the originally received packet and it is forwarded without any metadata to the next hop 136 for it to add its own metadata.

In another embodiment, a network element receiving the packet from a preceding network element determines whether adding its own metadata would exceed the packet's MTU limit at its egress interface. Based on the analysis and calculations performed to evaluate MTU capacity, the network element determines that 60% of its MTU limit is already occupied with previously embedded metadata from preceding network elements. The network element also determines that adding its own metadata would require 35% MTU capacity. If the network element embeds the packet and adds its own newly generated metadata, 95% the MTU capacity would be occupied (60% from preceding network elements and 35% from newly generated metadata). Because only 5% MTU capacity will remain to reach its maximum MTU capacity, the network element performs forward prediction analysis to determine a MTU threshold, i.e., the amount of MTU capacity that may be required by its next hop for the next hop network element to add its metadata to the data packet.

In one embodiment, the MTU threshold may be predetermined or determined based on calculations performed by the network element. For example, the receiving network element may set the MTU threshold by taking an average of the metadata embedded by preceding network elements. The threshold may also be determined by the next hop reporting back historical MTU limit used by previous packets received from the same flow.

In one embodiment, regardless of how the MTU threshold is determined, if for example the resulting threshold is 30%, then the network element would send a telemetry report with the 95% metadata to the collector and forward the originally received packet empty of any metadata to the next hop because the remaining MTU capacity of 5% is not sufficient to fit the predicted metadata capacity of 30% from the next hop.

Each downstream network element would perform similar analysis to determine MTU capacity until the packet reaches the last hop. If the network element is the last hop before the destination, then the network element, also referred to as the sink node, prepares and forwards a telemetry report containing metadata from preceding network elements as well as its own metadata to the designated collector. The last hop also strips the metadata from the originally received packet and removes the INT header before the data packet is forwarded to its destination node.

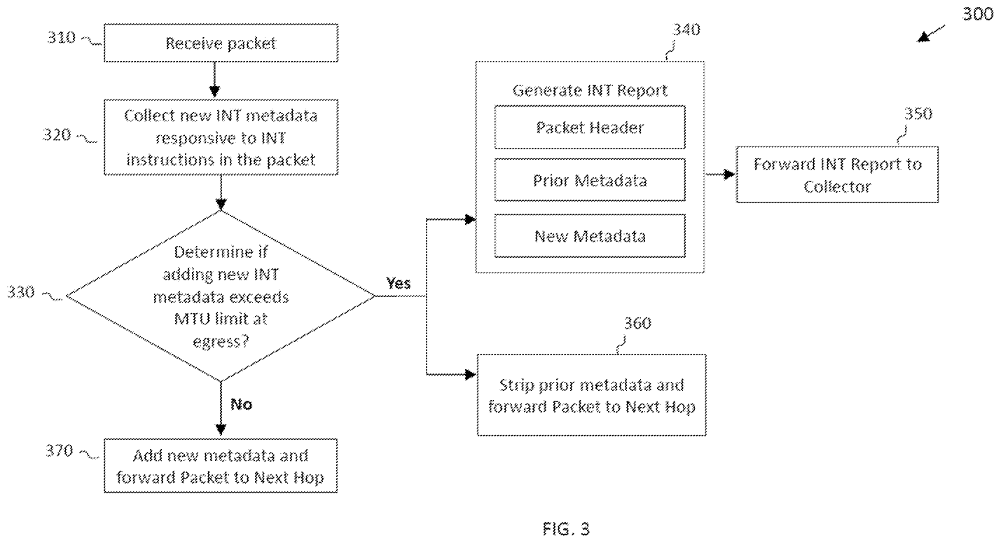

FIG. 3 is a flowchart of a process 300 performed by a network element for managing packet transmission capacity, in accordance with some embodiments of the disclosure. The packet transmission capacity is managed by process 300 to prevent uncontrolled growth of the packet such that the packet length stays within the allowed MTU limit at the egress of the network element.

At Block 310 a network element receives a data packet. The data packet may be received by the network element from an INT source. The INT source may be a computer, mobile device, or other electronic device capable of connecting to the components of system 100 through the network 130. The INT source may receive data packets from originating sources of traffic, such as a database or a web browser. Alternatively, the INT source may be both an originating source of data as well a source for embedding the data packet.

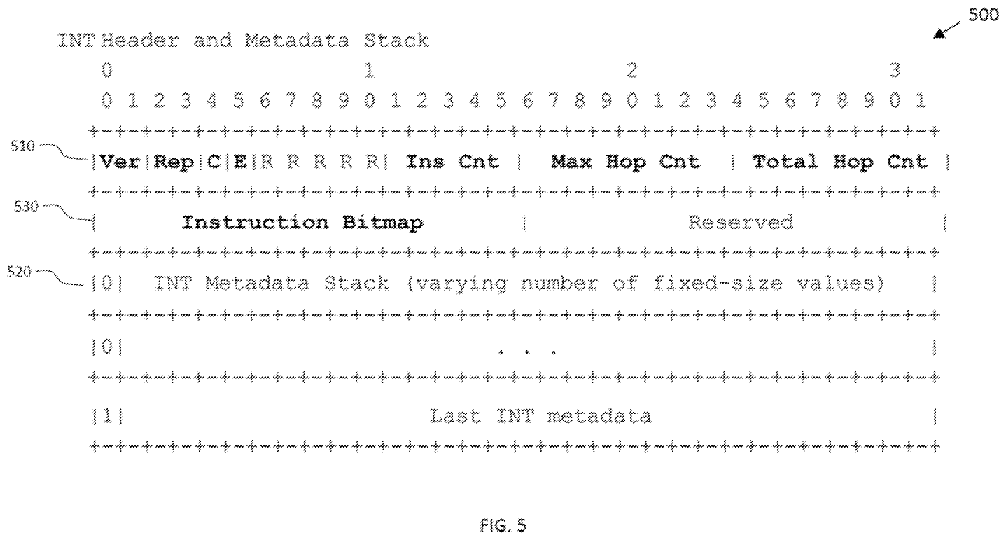

In one embodiment, the network element receives the data packet from an INT source. The INT source embeds the packet header with an INT header. The INT header includes INT instructions that instruct a downstream network element along the path of the packet on the type and quantity of telemetry metadata to forward to a designated collector. The INT instructions and other data embedded in the INT header are also referred to as INT data. An exemplary INT header is described in FIG. 5. If the data packet was received from an INT source, then it may not have any telemetry metadata embedded to the INT header of the data packet. Alternatively, the INT source may also embed its own metadata along with INT instructions.

In another embodiment, the network element receives the data packet from another network element that precedes it along the path of the packet to its destination. The data packet may or may not contain metadata generated from the preceding one or more network elements.

The data packet received at the network element, whether from an INT source or a preceding network element, includes a header, payload, and an INT header that may be embedded by the INT source. In one embodiment, the data packet does not include telemetry metadata from a preceding network element. A set of INT instructions that are included in the INT header guide the network element at Block 320 to collect new metadata M1.

In another embodiment, the network element receives the data packet from a preceding network element and the data packet includes a header, payload, an INT header, and metadata M1 and M2 from one or more preceding network elements. A set of INT instructions that are included in the INT header guide the network element at Block 320 to collect new metadata M3, i.e. its own newly generated metadata in response to the INT instructions provided.

At Block 330, the network element receiving the data packet, either from an INT source or from a preceding network element, performs an analysis to determine if adding its own newly generated metadata would exceed the packet's MTU limit at its egress interface. In one embodiment, the INT header of the data packet includes instructions for the network element to calculate packet MTU limit and determine if adding new metadata would exceed the packet's MTU limit at egress interface of the network element. In another embodiment, the network element is configured directly for calculating packet transmission capacity. It may be configured by a network administrator or by an automated method by a server of the system.

In one embodiment, the analysis to determine data packet MTU limit at egress is performed regardless of whether the data packet is received from the INT source or from a preceding network element in the path of the packet. Additionally, the MTU limit analysis is performed regardless of whether the data packet received at the ingress of the network element includes metadata from a prior network element.

In another embodiment, the analysis is performed only if it is determined that the data packet received at the ingress port of the network element contains metadata from a preceding network element. In one embodiment, metadata includes, for example, path information, latency information, jitter, bandwidth utilization, queue depth, and other packet related data.

At Block 330, if a determination is made that adding its own metadata, i.e. the newly generated metadata by the network element in response to the INT instructions, exceeds the packet's MTU limit at the egress interface of the network element, then the network element, at Block 340, prepares an INT report that includes prior metadata, which is metadata (such as 220, 225) from preceding network elements, newly generated metadata (such a 230), and the original packet header 205 and forwards the INT report at Block 350 to the INT collector. Additionally, at Block 360, the previously embedded metadata is stripped from the originally received data packet and the data packet without any metadata is forwarded to the next hop. In alternative embodiments, other checks, or tests at block 330 could trigger the sending of an INT report as described herein. For example, if the prior metadata reaches a certain number (for example the metadata from three prior network elements) or size, blocks 340-350 could be triggered.

If a determination is made that adding its own metadata, i.e. the newly generated metadata by the network element in response to the INT instructions, does not exceed the packet's transmission capacity at the egress interface of the network element, then the network element, at Block 370, embeds the packet by adding its own telemetry metadata. Subsequently, the network element forwards the packet to the next hop network element along the path of the packet to its destination host.

All next hops repeat the process until the packet reaches the last hop. If the network element is the last hop before the destination, then the network element, also referred to as the sink node, prepares and forward a telemetry report that includes all metadata, i.e., both metadata from preceding network elements as well as newly generated metadata, original packet header, and the INT header, to the INT collector. The last hop also strips the metadata from the received packet and removes the INT header before the data packet is forwarded to its destination node.

FIG. 4 is a flowchart for a process 400 to analyze packet transmission capacity, in accordance with some embodiments of the disclosure. At Block 410, a network element receiving a data packet at its ingress interface determines the packet transmission capacity of the data packet. It determines whether the data packet contains metadata that was previously embedded to the INT header of the data packet. The previous metadata may be from a network element that precedes the network element that received the data packet and the prior metadata may be metadata generated by the previous network element in response to the instructions provided in the INT header of the data packet.

At Block 420, the network element calculates the transmission capacity of the new metadata. This is metadata that will be generated by the network element in response to the instructions provided in the INT header of the data packet. The network element determines the type and quantity of metadata that is to be collected and then based on the type and quantity of metadata determines that capacity or space that will be required by the newly generated metadata.

In one embodiment, having calculated the existing metadata of the data packet as it was received at the ingress interface and having calculated required transmission capacity to add new metadata that will be generated by the network element, at Block 430, the network element determines whether the total MTU limit of the data packet would exceed if new metadata is added to the data packet. For example, the network element analyzes the total MTU limit of the data packet for being able to transmit the data packet through its egress interface to the next hop. Because the egress limit may vary for each network element, the network element ensures that the previous metadata and the newly added metadata together do not exceed the allowed egress limit.

In one embodiment, Block 430 to determine data packet MTU capacity at egress is performed regardless of whether the received data packet includes metadata from prior network elements. If there is no prior metadata embedded to the received packet, then the network element does not perform calculations and adds its own generated metadata to the data packet and forwards it to the next hop. In another embodiment, the packet transmission capacity determination is made automatically regardless of whether the received packet has prior metadata embedded to it.

Although a few methods of determination at Block 430 are described above, other determination methods are also contemplated. For example, a network element may determine total MTU limit allowed at its egress port and perform a calculation to determine a difference between total allowed MTU capacity and currently occupied MTU capacity to conclude whether the space remaining is sufficient to fit in the new metadata that is to be generated by the network element.

FIG. 5 is an exemplary INT header 500, in accordance with some embodiments of the disclosure. The INT metadata header 510 is 8 bits long and metadata values are encoded as 4-bits long values. The metadata stack 520 following the INT metadata header field 510 has a varying length and accommodates metadata from each hop/network element traversed by the packet, such as metadata M1-M5 as described in FIG. 2. Details of the metadata stack as well as determinations on whether to stack metadata from a network element when the stack includes metadata from previous network elements are described in FIGS. 6A and 6B.

The INT instructions 530 field of the INT header 500 are encoded in a 16-bit INT Instruction field where the they instruct specifically the type and quantity of metadata, such as latency information, jitter, bandwidth utilization, queue depth, is to be collected from each network element. Further details of the INT header are described in the following publication that is incorporated herein by reference: In-Band Network Telemetry (INT), June 2016, https://p4.org/assets/INT-current-spec.pdf. Authors Changhoon Kim, Parag Bhide, Ed Doe: Barefoot Networks, Hugh Holbrook: Arista, Anoop Ghanwani: Dell, Dan Daly: Intel and Mukesh Hira, Bruce Davie: VMware.

FIGS. 6A and 6B are block diagram of an INT metadata stack, in accordance with some embodiments of the disclosure. FIG. 6A depicts the metadata stack 520 of a data packet at its ingress port/interface. The metadata stack 520 is part of the INT header 500. FIG. 6B depicts the metadata stack 520 of the INT header 500 at the egress port/interface of the network element.

Referring to FIG. 6A, in one embodiment, at the ingress port of the network element, such as network element 134 in FIG. 2, the metadata stack includes metadata M1 (220) and M2 (225) that was previously embedded to the INT header 500 by network elements, such as network elements 120 and 132 in FIG. 2, that preceded the current network element 134 in the path of the packet to its destination. The length of the metadata stack is associated with the length of the packet transmission capacity, i.e., more metadata occupies more packet transmission capacity and makes the packet length longer.

As depicted in FIG. 6A, after the packet is received at the ingress interface of the network element 134, there is still some MTU capacity remaining even after the packet includes metadata M1 and M2 from previous network elements. However, FIG. 6B depicts that adding new metadata to the current stack may put the MTU limit over the allowed MTU limit at the egress of the network element 134.

Referring to FIG. 6A, in one embodiment, the network element 134 in response to the INT instructions is instructed to add new metadata M3 (230) to the metadata stack 520. The new metadata M3 (230), although can be added to the metadata stack, however, adding it would exceed the allowed MTU limit at the egress of the network element, e.g., the excess portion 650 of metadata 230 is shown as exceeding the MTU limit.

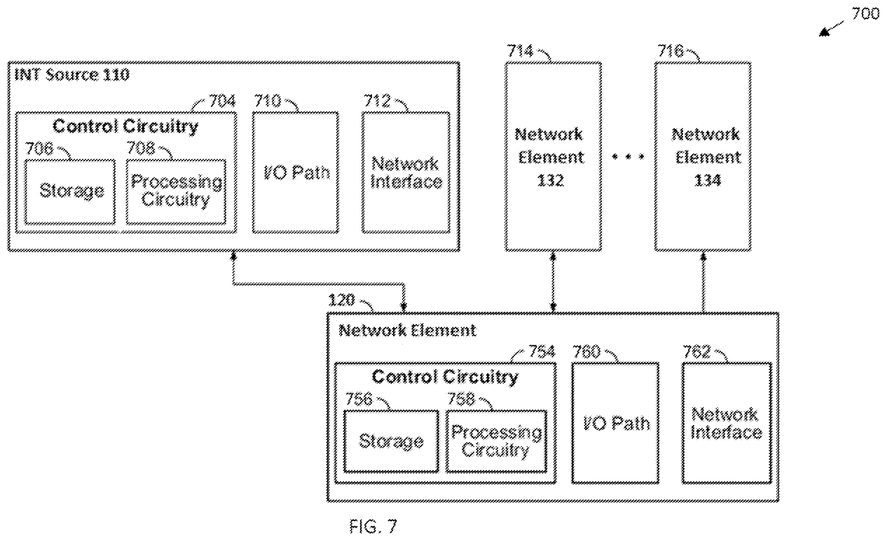

FIG. 7 shows a diagram of illustrative devices of a system 700 that includes INT source 110, network elements 120, 132, 134 (and other network element of FIGS. 1 and 2—Not shown shown).

INT source 110 may receive and send data via an input/output (I/O) path 710. I/O path 710 is communicatively connected to control circuitry 704, which includes processing circuitry 708 and storage (or memory) 706. Control circuitry 704 may send and receive commands, requests, and other suitable data using I/O path 710. I/O path 710 may connect control circuitry 704 (and specifically processing circuitry 708) to one or more network interfaces 712, which in turn connect the INT source 110 to other devices on the network (e.g., network elements 120, 132, and 134).

Control circuitry 704 may be based on any suitable processing circuitry, such as processing circuitry 708. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, octa-core, or any suitable number of cores). In some embodiments, processing circuitry is distributed across multiple separate processors or processing units, for example, multiple of the same type of processing units (e.g., two INTEL CORE i7 processors) or multiple different processors (e.g., an INTEL CORE i7 processor and an INTEL CORE i9 processor). In some embodiments, control circuitry 704 executes instructions stored in memory (i.e., storage 706). For example, the instructions may cause control circuitry 704 to perform packet forwarding, embedding of INT headers, embedding instructions for a downstream network element to calculate packet transmission capacity, and other INT operations described in this document.

Memory 706 may be an electronic storage device that is part of control circuitry 704. As referred to herein, the phrase “electronic storage device” or “storage device” should be understood to mean any device for storing electronic data, computer software, instructions, and/or firmware, such as random-access memory, hard drives, optical drives, solid state devices, quantum storage devices, or any other suitable fixed or removable storage devices, and/or any combination of the same. Nonvolatile memory may also be used. The circuitry described herein may execute instructions included in software running on one or more general purpose or specialized processors.

Control circuitry 704 may use network interface 712 to receive and forward packets to other network devices 714-716 (which may include hardware similar to that of network element 120), e.g., over any kind of a wired or wireless network.

Memory 706 may include instructions for embedding packet headers with INT instructions, embedding instructions for a downstream network element to calculate packet transmission capacity, and handling INT packets to collect and forward telemetry data as described above.

INT source 110 may include I/O path 760, network interface 762, and control circuitry 754 that includes processing circuitry 758 and storage 756. These elements may function similarly to elements 704-712 as described above. INT source 110 may be configured to receive and forward packets and collector 180 may be configured to receive telemetry data, such as mirrored packets or telemetry report, from packets from all networking elements in the network via network interface 762.

It will be apparent to those of ordinary skill in the art that methods involved in the present invention may be embodied in a computer program product that includes a computer-usable and/or -readable medium. For example, such a computer-usable medium may consist of a read-only memory device, such as a CD-ROM disk or conventional ROM device, or a random-access memory, such as a hard drive device or a computer diskette, having a computer-readable program code stored thereon. It should also be understood that methods, techniques, and processes involved in the present disclosure may be executed using processing circuitry.

The processes discussed above are intended to be illustrative and not limiting. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted, the systems and/or methods described above may be applied to, or used in accordance with, other systems and/or methods.

1. A method of managing packet transmission in an in-band telemetry (INT) capable network, the method comprising:
receiving, by a network element, a packet comprising INT data;
determining, by the network element, if adding new INT metadata to the packet exceeds transmission capacity of the packet; and
in response to determining that adding the new INT metadata exceeds the transmission capacity of the packet:
generating a telemetry report containing existing INT metadata and new INT metadata, and
forwarding the telemetry report to an INT collector and the packet without any metadata to a next hop.

2. The method of claim 1, wherein determining if adding the new INT metadata to the packet exceeds the transmission capacity further comprising:
identifying the total transmission capacity of the packet;
determining transmission capacity occupied by the existing INT metadata in the packet;
calculating the difference between the total transmission capacity and transmission capacity occupied by the existing INT metadata to determine remaining transmission capacity; and
determining if the transmission capacity required by the new INT metadata is within the remaining transmission capacity.

3. The method of claim 1, further comprising:
in response to determining that adding new INT metadata does not exceed the transmission capacity of the packet,
adding the new INT metadata to the packet, and
forwarding the packet with the added new INT metadata to the next hop along the path of the packet to its destination.

4. The method of claim 1, wherein stripping the existing INT metadata comprises extracting metadata stored in an INT header field of the packet.

5. The method of claim 1, wherein the new INT metadata is metadata generated by the network element based on INT instructions provided in the packet and the existing INT metadata is metadata generated by one or more network elements prior to the packet arriving at an ingress port of the network element.

6. The method of claim 1, wherein the transmission capacity of the packet is the maximum operating transmission capacity at which the network element can forward the packet from its egress port to the next hop.

7. The method of claim 1, wherein the packet includes an INT header having INT instructions.

8. The method of claim 7, wherein the INT instructions indicate to the network element to collect the type and quantity of the new INT metadata as required by the INT instructions.

9. The method of claim 1, wherein INT data includes INT instructions and INT metadata.

10. The method of claim 1, further comprising the network element performing a forward prediction analysis, wherein the analysis comprises:
determining a threshold, wherein the threshold is an estimated amount of the transmission capacity of the packet required by the next hop to embed its own metadata to the packet; and
in response to not meeting the threshold:
generating the telemetry report; and
forwarding the received packet without any metadata to the next hop and the telemetry report to the INT collector.

11. A method for in-band telemetry (INT), the method comprising:
embedding a packet header, by an INT source, with INT instructions to create a packet comprising INT data, wherein the INT data indicates to a network element encountered by the packet along its path to:
determine if adding new INT metadata to the packet exceeds transmission capacity of the packet; and
in response to determining that adding the new INT metadata exceeds the transmission capacity of the packet:
strip existing INT metadata from the packet, and
forward the existing INT metadata to an INT collector to create space for adding the new INT metadata without exceeding the transmission capacity of the packet.

12. The method of claim 11, wherein determining if adding the new INT metadata to the packet exceeds the transmission capacity further comprising:
identifying the total transmission capacity of the packet;
determining transmission capacity occupied by the existing INT metadata in the packet;
calculating the difference between the total transmission capacity and transmission capacity occupied by the existing INT metadata to determine remaining transmission capacity; and
determining if the transmission capacity required by the new INT metadata is within the remaining transmission capacity.

13. The method of claim 11, further comprising:
in response to determining that adding new INT metadata does not exceed the transmission capacity of the packet,
adding the new INT metadata to the packet, and
forwarding the packet with the added new INT metadata to the next hop along the path of the packet to its destination.

14. The method of claim 11, wherein stripping the existing INT metadata comprises extracting metadata stored in an INT header field of the packet.

15. The method of claim 11, wherein the new INT metadata is metadata generated by the network element based on INT instructions provided in the packet and the existing INT metadata is metadata generated by one or more network elements prior to the packet arriving at an ingress port of the network element.

16. An in-band telemetry (INT) capable device comprising:
a network interface of the INT capable device configured to receive a plurality of packets, each packet comprising INT data; and
control circuitry configured to:
receive the packet;
determine if adding new INT metadata to the packet exceeds transmission capacity of the packet; and
in response to determining that adding the new INT metadata exceeds the transmission capacity of the packet:
generate a telemetry report containing existing INT metadata and new INT metadata, and
forward the telemetry report to an INT collector and the packet without any metadata to a next hop.

17. The device of claim 16, wherein determining if adding the new INT metadata to the packet exceeds the transmission capacity further comprising:
identifying the total transmission capacity of the packet;
determining transmission capacity occupied by the existing INT metadata in the packet;
calculating the difference between the total transmission capacity and transmission capacity occupied by the existing INT metadata to determine remaining transmission capacity; and
determining if the transmission capacity required by the new INT metadata is within the remaining transmission capacity.

18. The device of claim 16, further comprising:
in response to determining that adding new INT metadata does not exceed the transmission capacity of the packet,
adding the new INT metadata to the packet, and
forwarding the packet with the added new INT metadata to the next hop along the path of the packet to its destination.

19. The device of claim 16, wherein stripping the existing INT metadata comprises extracting metadata stored in an INT header field of the packet.

20. The device of claim 16, wherein the new INT metadata is metadata generated by the INT capable device based on INT instructions provided in the packet and the existing INT metadata is metadata generated by one or more INT capable devices prior to the packet arriving at an ingress port of the network element.
